(19) United States
(12) Patent Application Publication
(10) Pub. No.: US 2009/0219434 A1
(43) Pub. Date: Sep. 3, 2009

(54) Method and Device for Position Sensing of an Optical Component in an Imaging System

(76) Inventor: Petteri Kauhanen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/223,507

(22) PCT Filed: Feb. 6, 2006
(86) PCT No.: PCT/IB2006/000218

§ 371 Date: Feb. 18, 2009

(51) Int. Cl. H04N 5/232

(52) U.S. Cl. 348/345; 348/E05.045

(57) ABSTRACT

In a camera where the lens is movable along the optical axis relative to the image sensor for auto-focus or zooming purposes, the lens is moved by a carrier having a carrier portion adjacent to a fixed body portion of the camera. A reflection surface is provided on either the carrier portion or the body portion. A photo-emitter and sensor pair is disposed on the other portion to illuminate the reflection surface and to detect the reflected light therefrom. The reflection surface is provided near the edge of a surface such that the light cone emitted by the photo-emitter partly hits the reflection surface and partly falls beyond the edge. As the lens is moved relative to the body portion, the area on the reflection surface illuminated by the photo-emitter changes causing a change in the amount of detected light.

### FIELD OF THE INVENTION

The present invention relates generally to optical position sensing in an imaging system and, more particularly, to position sensing for auto-focus optics and/or an optical zoom module in the imaging system.

### BACKGROUND OF THE INVENTION

Auto-focus optical systems require high precision in position sensing. In general, needed accuracy is in the order to a few microns. Sensor output linearity and immunity to external disturbances is important. Furthermore, the operation mode for position sensing also requires non-contact operation to avoid mechanical wear. When considering optics for use in a small electronic device, such as mobile phone, the size and cost of the optical sensing components and the suitability to mass production are important issues.

Typically, position determination in a commercial auto-focus module is carried out by counting stepper motor steps. For that purpose, the motor can have an embedded position encoder. In order to reduce the size of the optical modules, miniature piezoelectric motors or actuators are generally used. These motors and actuators require a separate position sensor.

In fulfilling the need for an auto-focus optical system or an optical zoom system with movement in the order of a few microns, the present invention provides a simple method and device for position sensing.

### SUMMARY OF THE INVENTION

The present invention uses a reflection surface to reflect light, and a photo-emitter and photo-sensor pair to illuminate the reflection surface and to detect the reflected light from the reflection surface. In particular, the reflection surface is provided near the edge of a first mounting member and the photo-emitter/sensor pair is disposed on a second mounting member. The first and second mounting members are moved relative to each other when the first mounting member is used to move a lens element in an auto-focus system or an optical zoom system. The photo-emitter/sensor pair is positioned at a distance from the reflection surface such that the light cone emitted by the photo-emitter only partly hits the reflection surface. Part of the light cone misses the reflection surface because it falls beyond the edge. As the photo-emitter/sensor pair and the reflection surface move relative to each other, the area on the reflection surface illuminated by the photo-emitter changes. Accordingly, the amount of light sensed by the photo-sensor also changes. The change in the reflected light amount causes a near-linear output signal response in a certain travel range of the reflection surface. Preferably, the reflectivity of the reflection surface within the illuminated area is substantially uniform and the distance between the photo-emitter/sensor pair and the reflection surface is substantially fixed. As such, the output signal response is substantially proportional to a portion of a circular area of a fixed radius and the portion is reduced or increased as a function of a moving distance as the photo-emitter/sensor pair and the reflection surface move relative to each other.

In one of the embodiments of the present invention, the diameter of the illuminated area is smaller than the width of the reflection surface.

In another embodiment of the present invention, the diameter of the illuminated area is equal to or greater than the width of the reflection surface.

In yet another embodiment of the present invention, the reflection surface has a wedge shape.

In a different embodiment of the present invention, two photo-emitter/sensor pairs disposed at two reflection surfaces for sensing the relative movement in a differential way.

The present invention will become apparent upon reading the description taken in conjunction with FIGS. 2a to 9.

### BRIEF DESCRIPTION OF THE DRAWINGS

FIG. 1 is a schematic representation of an imaging system wherein one or more lens elements are moved relative to the image sensor along the optical axis for focusing or zooming purposes.

FIG. 2a shows a photo-emitter/sensor pair positioned in relationship with a reflection surface near an edge of a mounting beam.

FIG. 2b is another view of the photo-emitter/sensor pair and the reflection surface.

FIG. 2c shows another embodiment of the present invention.

FIG. 3a shows a lens carrier having a mounting beam for mounting the photo-emitter/sensor pair.

FIG. 3b shows a lens carrier having a mounting beam for mounting the reflection surface.

FIG. 4a is a schematic representation of a camera having a photo-emitter/sensor pair fixedly mounted on a stationary part of the camera body.

FIG. 4b is a schematic representation of a camera having a reflective surface for folding the optical axis.

FIG. 5 shows a plot of output signal against the relative position between a photo-emitter/sensor pair and the reflection surface.

FIG. 6 shows another embodiment of the present invention.

FIG. 7 shows yet another embodiment of the present invention.

FIG. 8 shows two photo-emitter pairs positioned in relationship to two separate reflection surfaces near two edges of a mounting beam.

FIG. 9 shows a position sensing system, according to the present invention.

### DETAILED DESCRIPTION OF THE INVENTION

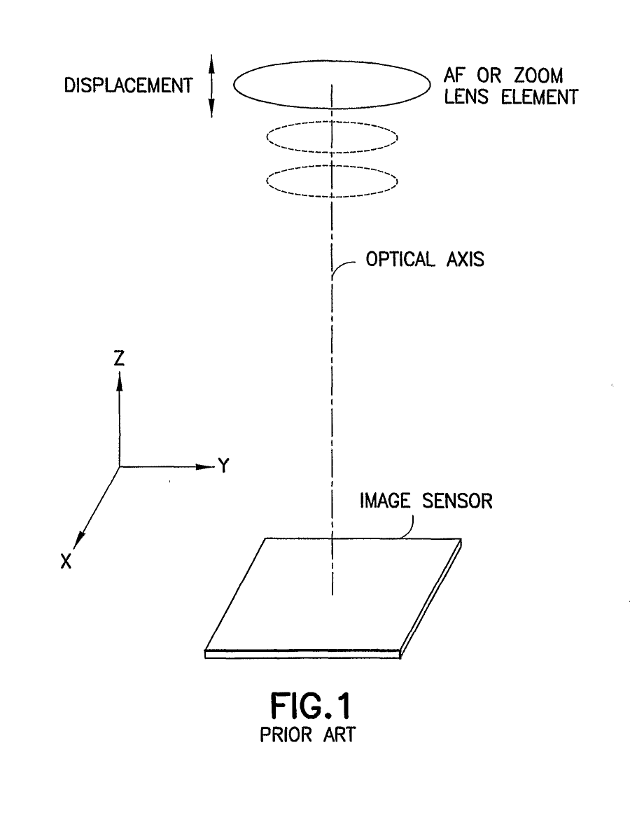

Imaging applications such as auto-focus lens systems and optical zoom systems require high precision in position sensing. In such applications, at least one lens element is moved along the optical axis of the imaging system so as to change the focal plane of the lens or the magnification of the image formed on an image sensor. As shown in FIG. 1, the movement of the lens element is substantially along the optical axis which is parallel to the Z axis. The image sensor is located in an image plane which is substantially parallel to the XY plane. The imaging system may have one or more stationary lens elements as depicted in dotted lines.

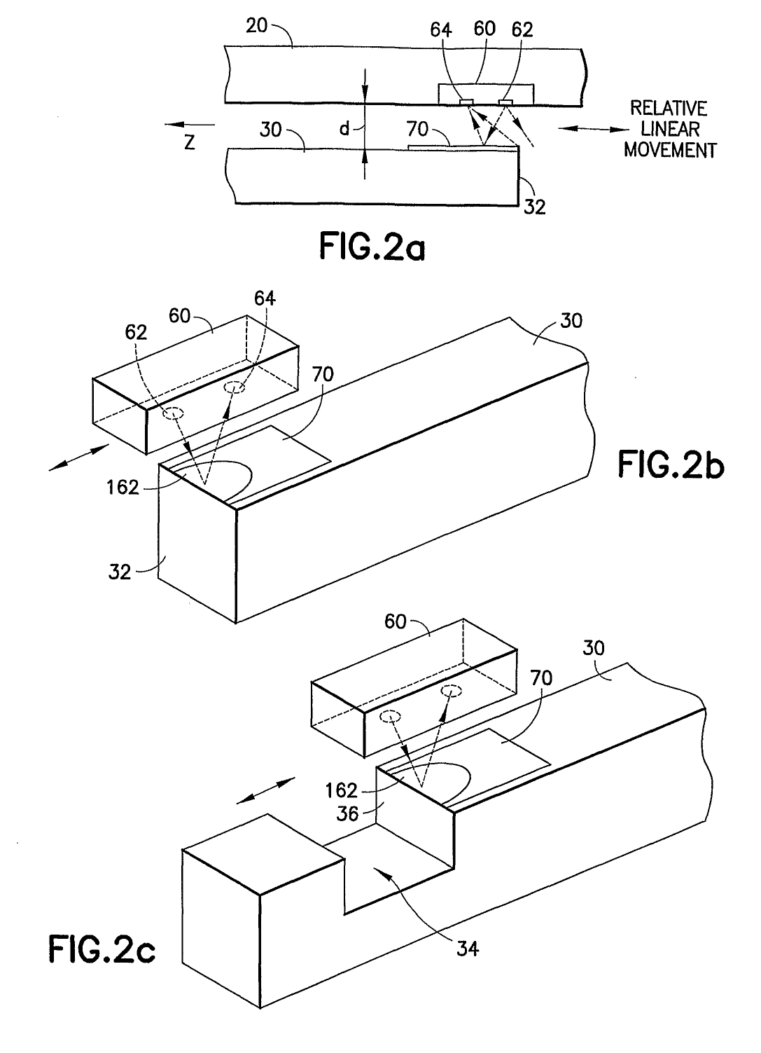

In auto-focus or optical zoom applications, it is required to determine the position of the lens element relative to a reference point or a home position. According to the present invention, a photo-emitter/sensor pair is used to sense the displacement of the lens element along the Z-axis. As shown in FIG. 2a, a reflection surface 70 is provided on a mounting member or mounting beam 30 and the photo-emitter/sensor pair 60 is disposed on a mounting member or mounting beam 20. The photo-emitter/sensor pair 60 has a photo-emitting element, such as an LED 62, for illuminating part of the reflection surface 70. The emitter/sensor pair 60 also has a photo-sensor 64 to sense the amount of light reflected by the reflection surface 70. Preferably, the reflectivity of the reflection surface within the illuminated area is substantially uniform and the distance, d, between the photo-emitter/sensor pair 60 and the reflection surface 70 is also fixed.

As shown in FIG. 2b, the reflection surface 70 is provided next to an edge of the mounting beam 30. The distance and position between the emitter/sensor pair 60 and the reflection surface 70 is chosen such that the light cone 162 emitted by the photo-emitting element 62 only partially hits the reflection surface 70. Part of the light cone 162 misses the reflection surface 70 as it falls beyond the edge 32 of the mounting beam 30. As such, the output signal response from the photo-sensor 64 is substantially proportional to a portion of a circular area of a fixed radius and the portion is reduced or increased as a function of a moving distance as the photo-emitter/sensor pair and the reflection surface move relative to each other.

It should be noted that the edge of a mounting beam is not necessarily formed at an end of the mounting beam, as shown in FIGS. 2a and 2b. The edge can be made with a slot on the beam, for example. As shown in FIG. 2c, the beam 30 has a slot 34 with an edge 36. The photo-emitter/sensor pair 60 is positioned on its mounting beam near the slot 34 so that the light cone emitted by the photo-emitter 62 hits only part of the reflection surface 70.

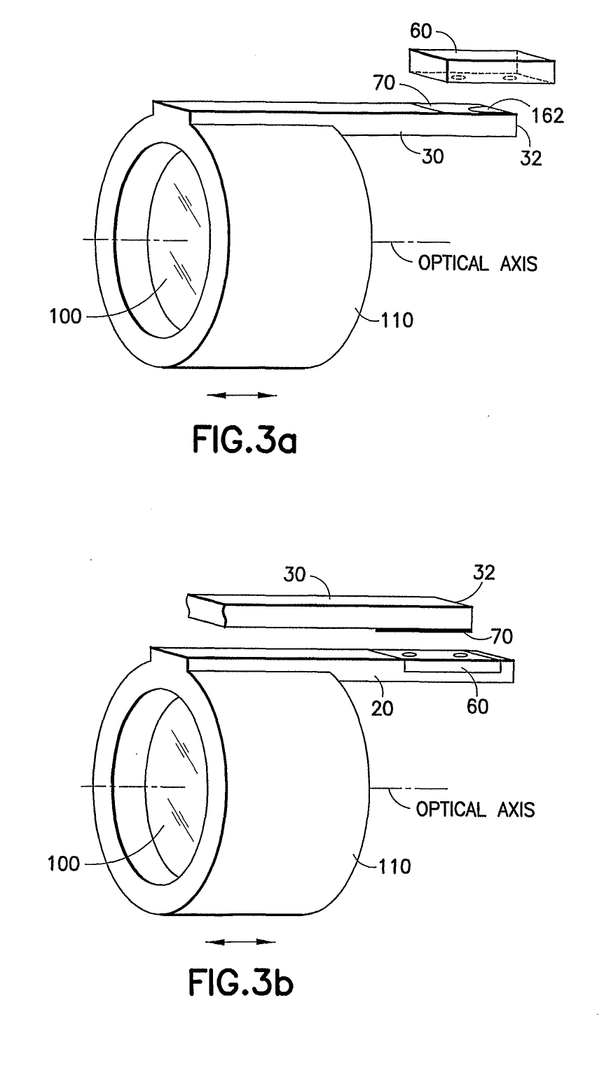

FIG. 3a shows one embodiment of the present invention where the mounting beam 30 is fixedly mounted on a lens carrier 110 or is an integral part of the lens carrier. The lens carrier 110 is used to move the lens element 100 along the optical axis for auto-focus or optical zoom purposes. FIG. 3b shows another embodiment of the present invention where the mounting beam 20 is fixedly mounted on the lens carrier 110.

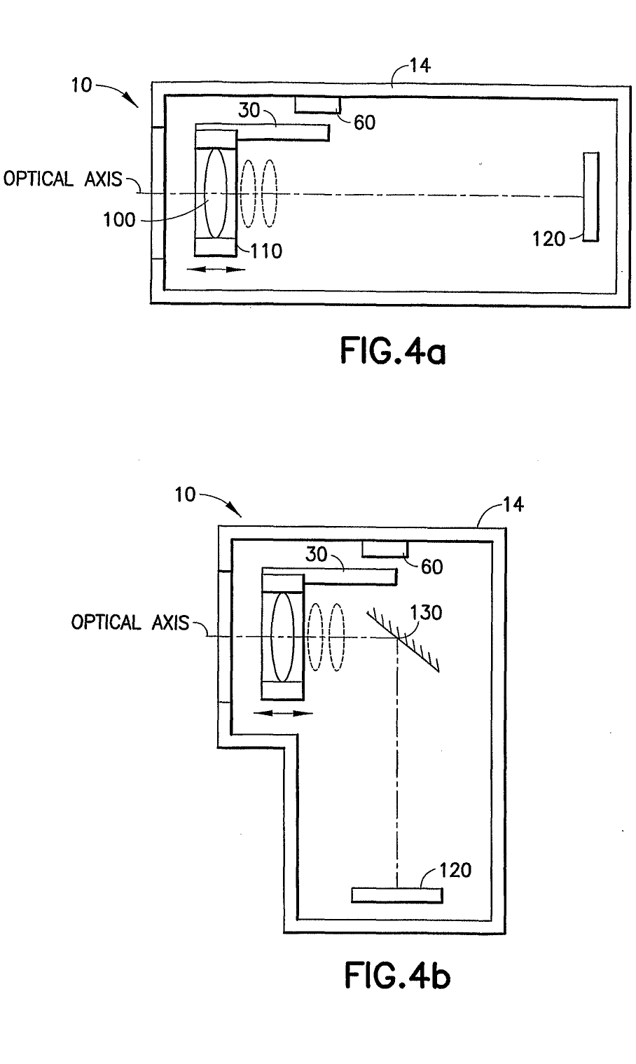

FIG. 4a is a schematic representation of an imaging system or camera 10 of the present invention. The imaging system 10 has a stationary body 14 for fixedly mounting the photo-emitter/sensor pair 60. The lens element 100 is movable together with the lens carrier 110 along the optical axis in order to form an image at a focal plane on the image sensor 120. As shown, the mounting beam 30 is fixedly mounted on the lens carrier 110. It should be noted that the position sensing system of the present invention can also be used in an imaging system where the optical axis is folded by a reflective surface 130, as shown in FIG. 4b.

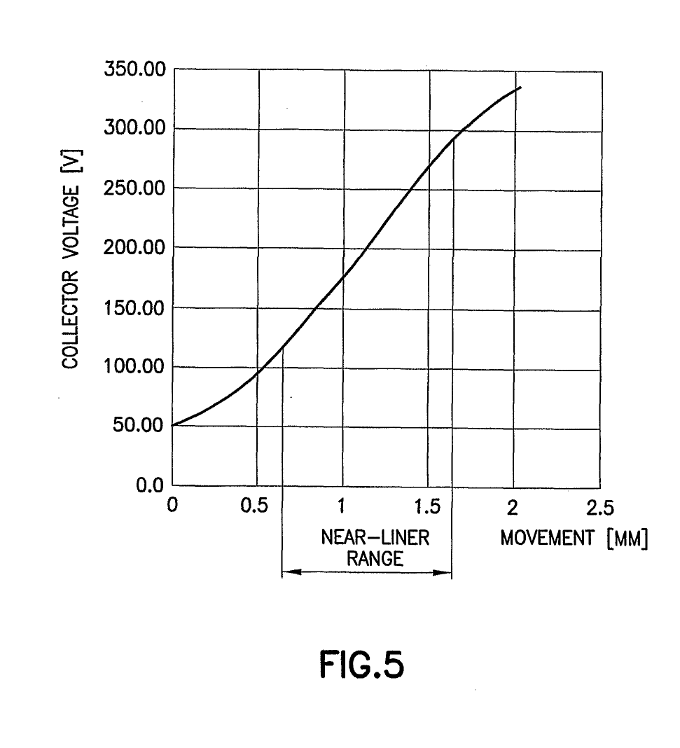

It is understood by a person skilled in the art that the photo-emitter/sensor pair 60 is operatively connected to a power supply for providing electrical power to the photo-emitter 62 and to an output measurement device so that the output signal from the photo-sensor 64 can be measured for determining the relative movement between the photo-emitter/sensor 60 pair and the reflection surface 70. The measured output signal from the photo-sensor 64, in terms of collector voltage as a function of movement distance, is shown in FIG. 5. As shown, a near-linear range of approximately 1 mm can be found in the middle section of the curve. Within this range, the measurable movement in the order of a few microns is attainable.

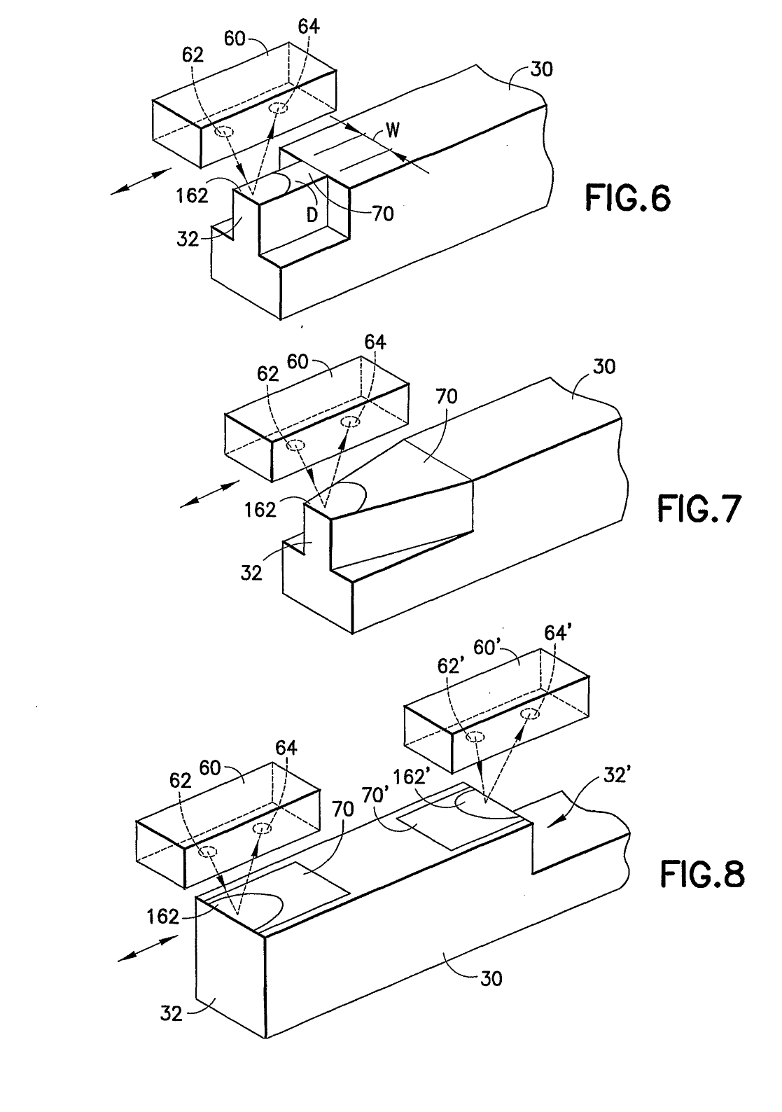

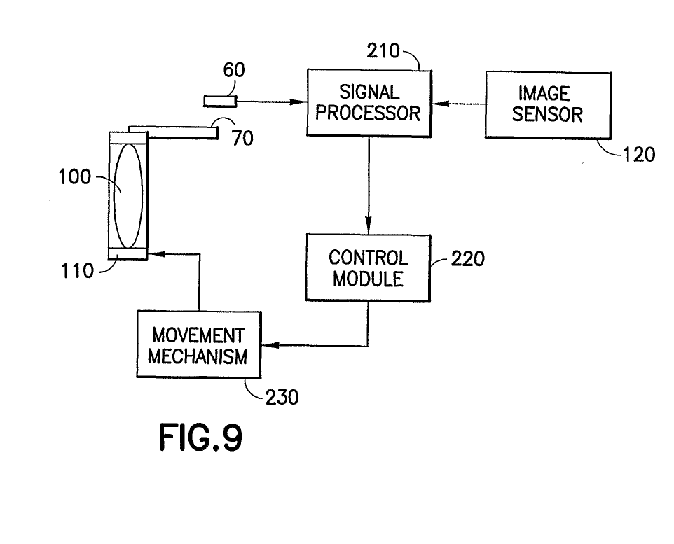

It should be appreciated by a person skilled in the art that the edge 32, 36 and 26 as depicted in FIGS. 2a to 3b is part of a beam surface that is substantially perpendicular to the reflection surface. However, the angle between the beam surface and the reflection surface is not necessarily a right angle. The angle can be larger than 90 degrees or small than 90 degrees, so long as the part of the light beam from the photo-emitter 62 falling beyond the edge does not yield a significant amount of detectable light as compared to the reflected light from the reflection surface. Furthermore, in FIGS. 2b and 2c, the width of the reflection surface 70 is greater than the diameter of the light cone 162 on the reflection surface. However, the width w of the reflection surface 70 can be equal to or smaller than the diameter D of the light cone 162 on the reflection surface, as shown in FIG. 6. Moreover, the reflection surface 70 can also be a wedge-shaped surface, as shown in FIG. 7.

In a different embodiment of the present invention, two separate optical sensors are used on one motion axis to form a differential position sensing system. As shown in FIG. 8, a photo-emitter/sensor pair 60 has a photo-emitter 62 for projecting a light cone 162 on a reflection surface 70, and a photo-sensor 64 for sensing the amount of light reflected by the reflection surface 70. A separate photo-emitter/sensor pair 60′ has a photo-emitter 62′ for projecting a light cone 162′ on a different reflection surface 70′, and a photo-sensor 64′ for sensing the amount of light reflected by the reflection surface 70′. As shown in FIG. 8, the reflection surface 70 is provided near an edge 32 of the mounting beam 30, and the reflection surface 70′ is provided near another edge 32′ of the same beam 30. The distance between the photo-emitter pair 70 and the photo-emitter pair 70′ is fixed so that when the position signal of one photo-emitter pair is increased due to the relative movement between mounting member 30 and the photo-emitter pairs, the position signal of the other photo-emitter pair is decreased. As such, the final position signal is the difference of the two separate position signals. With the arrangement as shown in FIG. 8, external influences such as temperature changes can be substantially eliminated. Furthermore, the effect of mechanical tilting is reduced.

It should be noted that optical sensors such as photo-emitter/sensor pairs are low-end components and, thus, the performance variation is generally quite large. It would be advantageous and desirable to calibrate the position system during start-up of the auto-focus or optical zoom system. This can be done by driving the lens element 100 over the entire available motion range, for example. During this stroke, the sensor output is measured at both extremes of the motion range. When the output signals at the two extremes are known, all the intermediate positions can be accurately determines from the intermediate output signals.

It should be appreciated by a person skilled in the art that the position sensing system 200 of the present invention also includes a movement mechanism 230, such as a piezoelectric actuator or a motor, for moving the lens carrier 110 and a signal processing module 210 operatively connected to the photo-emitter/sensor pair 60 for determining the position of the lens element 100 based on the reflection from the reflection surface 70. The position sensing system 200 also includes a control module 220 to control the movement amount of the lens element 100 via the movement mechanism 230, based on the information provided by the signal processing module 210. For auto-focus purposes, the signal processing module 210 may be required to receive image data from the image sensor 120 for checking the focus in part of the image formed on the image sensor 120. It should be noted that, however, the signal processing module 210, the control module 220 and the movement mechanism 230 are known in the art. They are not part of the present invention. The present invention is concerned with using at least one photo-emitter/sensor pair to sense the position of a reflection surface which is fixedly positioned in relationship to a lens element for auto-focusing or optical zoom purposes.

In an auto-focus system, it is possible to move the image sensor relative to the lens element. In that case, the position sensing system is used to sense the position of the image sensor, instead of sensing the position of the lens element.

Thus, although the invention has been described with respect to one or more embodiments thereof, it will be understood by those skilled in the art that the foregoing and various other changes, omissions and deviations in the form and detail thereof may be made without departing from the scope of this invention.

1. An imaging system comprising:
an image forming medium located at an image plane;
at least a lens element for projecting an image on the image forming medium, the lens element defining an optical axis;
a lens carrier for moving the lens element relative to the image forming medium in a direction substantially parallel to the optical axis so as to affect the projected image on the image forming medium, wherein the lens carrier is movable relative to a body portion of the imaging system and the lens carrier has a carrier portion adjacent to the body portion;
a position sensor arranged to sense the position of the lens carrier relative to the body portion, said position sensor comprising:
a reflection surface provided on one of the carrier portion and the body portion, the reflection surface located adjacent to an edge of a part surface,
a light emitting element, disposed on the other of the carrier portion and the body portion spaced from the reflection surface, for producing a light beam to illuminate the reflection surface such that part of the light beam encounters the reflection surface to form an illuminated area, and part of the light beam falls off the edge of the part surface, and
a light sensor arranged to sense the light reflected from the illuminated area for providing an electrical output having a relationship to the illuminated area, wherein when the lens carrier is caused to undergo a movement relative to the body portion, the illuminated area changes in response to said relative movement; and
a processor configured to compute the amount of the relative movement from the electrical output based on the relationship between the electrical output and the illuminated area.

2. The imaging system of claim 1, further comprising:
a driving mechanism, operatively connected to the lens carrier for moving the lens carrier.

3. The imaging system of claim 1, wherein the image forming medium comprises an image sensor.

4. The imaging system of claim 1, wherein the position sensing module further comprises:
a further reflection surface provided on said one of the carrier portion and the body portion, the further reflection surface located adjacent to a different edge of the part surface, and
a further light emitting element, disposed on said other of the carrier and body portions spaced from the further reflection surface, for producing a different light beam to illuminate the further reflection surface such that one part of the different light beam encounters the further reflection surface to form a different illuminated area, and another part of the different light beam falls off the different edge of the part surface,
a further light sensor for sensing the light reflected from the different illuminated area for providing a further electrical output having a relationship to the different illuminated area, so as to allow the processor to determine the relative movement also from the further electrical output.

5. The imaging system of claim 4, wherein the relative movement is at least determined based on a difference between the electrical output and the further electrical output.

6. A method for position sensing in an imaging system, said method comprising:
providing a reflection surface in the imaging system, the imaging system comprising a plurality of imaging components arranged in relationship to an optical axis, the imaging components comprising at least an image forming medium and a lens element for projecting an image on the image forming medium, wherein one of the imaging components is movable relative to the other in a direction substantially parallel to the optical axis, and wherein the imaging system also comprises a first part fixedly positioned in relationship to the image forming medium and a second part fixedly positioned in relationship to the lens element, wherein the reflection surface is provided on one of the first and second parts, adjacent to an edge of a part surface;
disposing a light emitting element on the other one of the first and second parts, wherein the light emitting element is positioned to produce a light beam for illuminating the reflection surface such that one part of the light beam encounters the reflection surface to form an illuminated area, and another part of the light beam falls off the edge of the part surface;
sensing the light reflected from the illuminated area for providing an electrical output having a relationship to the illuminated area, wherein when a relative movement between the first and the second part is caused to occur, the illuminated area changes in response to said relative movement; and
determining the amount of the relative movement from the electrical output based on the relationship between the electrical output and the illuminated area.

7. The method of claim 6, further comprising:
providing a further reflection surface adjacent to a further edge of the part surface;
disposing a farther light emitting element on said other one of the first and second parts, wherein the further light emitting element is positioned to produce a different light beam for illuminating the further reflection surface such that one part of the different light beam encounters the farther reflection surface to form a further illuminated area, and another part of the different light beam falls off the further edge of the part surface;
sensing the light reflected from the farther illuminated area for providing a further electrical output having a relationship to the further illuminated area;
determining the difference between the electrical output and the further electrical output for providing a differential output; and
determining the amount of the relative movement from the differential output.

8. The method of claim 6, wherein the second part is movable relative to the first part along a moving direction and the reflection surface has a width perpendicular to the moving direction, and that the illuminated area has a diameter smaller than the width of the reflection surface.

9. The method of claim 6, wherein the second part is movable relative to the first part along a moving direction and the reflection surface has a width perpendicular to the moving direction, and that the illuminated area has a diameter equal to the width of the reflection surface.

10. The method of claim 6, wherein the second part is movable relative to the first part along a moving direction and the reflection surface has a width perpendicular to the moving direction, and that the illuminated area has a diameter greater than the width of the reflection surface.

11. The method of claim 6, wherein the second part is movable relative to the first part along a moving direction and the reflection surface has a width varied along an axis parallel to the moving direction.

12. A lens moving module for use in an imaging system, said lens moving module comprising:
a lens carrier for moving a lens element defining an optical axis in the imaging system, the imaging system comprising an image sensor located at an image plane of said lens element, the lens element arranged to project an image on the image sensor, wherein the lens element movable relative to the image sensor in a direction substantially parallel to the optical axis so as to affect the projected image on the image sensor, wherein the lens carrier is movable relative to a body portion of the imaging system and the lens carrier has a carrier portion adjacent to the body portion;
a position sensor configured to sense the position of the lens carrier relative to the body portion, said position sensor comprising:
a reflection surface provided on one of the carrier portion and the body portion, the reflection surface located adjacent to an edge of a part surface,
a light emitting element, disposed on the other of the carrier and body portions spaced from the reflection surface, for producing a light beam to illuminate the reflection surface such that one part of the light beam encounters the reflection surface to form an illuminated area, and another part of the light beam falls off the edge of the part surface, and
a light sensor arranged to sensor the light reflected from the illuminated area for providing an electrical output having a relationship to the illuminated area, wherein when the lens carrier is caused to undergo a movement relative to the body portion, the illuminated area changes in response to said relative movement;
a processor configured to compute the amount of the relative movement from the electrical output based on the relationship between the electrical output and the illuminated area so as to determine a current position of the lens element relative to a reference position;
a movement controller for determining an amount for moving the lens element based on the current position of the lens element; and
a driving mechanism for moving the lens carrier based on the determined amount.

13. The lens moving module of claim 12, wherein the position sensing module further comprises:
a further reflection surface provided on said one of the carrier and body portions, the further reflection surface located adjacent to a different edge of the part surface, and
a further light emitting element, disposed on said other of the carrier and body portions spaced from the further reflection surface, for producing a different light beam to illuminate the further reflection surface such that one part of the different light beam encounters the further reflection surface to form a different illuminated area, and another part of the different light beam falls off the different edge of the part surface,
a further light sensor for sensing the light reflected from the different illuminated area for providing a further electrical output having a relationship to the different illuminated area, so as to allow the processor to determine the relative movement also from the further electrical output.

14. The lens moving module of claim 13, wherein the relative movement is determined at least based on a difference between the electrical output and the further electrical output.

15. A position sensing module for use in an imaging system, said position sensing module comprising:
a reflection surface in the image system, the imaging system comprising a plurality of imaging components, the imaging component comprising an image sensor located in an image plane and a lens element for projecting an image on the image sensor, the lens element defining an optical axis, wherein one of the imaging components is mounted on a carrier for movement in a direction substantially parallel to the optical axis for affecting the projected image on the image sensor, the carrier having a carrier portion adjacent a fixed body portion of the image system, and wherein the reflection surface is provided on one of the carrier portion and the body portion, wherein the reflection surface is located near an edge of a part surface;
a light emitting element, disposed on the other of the carrier and body portions spaced from the reflection surface, for producing a light beam to illuminate the reflection surface such that one part of the light beam encounters the reflection surface to form an illuminated area, and another part of the light beam falls off the edge of the part surface, wherein when the carrier is caused to move relative to the body portion, the illuminated area changes; and
a light sensor for sensing the light reflected from the illuminated area for providing an electrical output having a relationship to the illuminated area so as to determine the relative movement amount from the electrical output based on the relationship between the electrical output and the illuminated area.

16. The position sensing module of claim 15, further comprising:
a further reflection surface adjacent to a further edge of the part surface;
a further light emitting element, disposed on the other of the carrier and body portions spaced from the further reflection surface, for producing a different light beam to illuminate the further reflection surface such that one part of the different light beam encounters the further reflection surface to form a further illuminated area, and another part of the different light beam falls off the further edge of the part surface; and
a further light sensor for sensing the light reflected from the further illuminated area for providing a further electrical output having a relationship to the further illuminated area so that the relative movement amount is also determined from the further electrical output based on the relationship between the further electrical output and the further illuminated area.

17. The position sensing module of claim 15, wherein the carrier is movable relative to the body portion along a moving direction and the reflection surface has a width perpendicular to the moving direction, and that the illuminated area has a diameter smaller than the width of the reflection surface.

18. The position sensing module of claim 15, wherein the carrier is movable relative to the body portion along a moving direction and the reflection surface has a width perpendicular to the moving direction, and that the illuminated area has a diameter equal to the width of the reflection surface.

19. The position sensing module of claim 15, wherein the carrier is movable relative to the body portion along a moving direction and the reflection surface has a width perpendicular to the moving direction, and that the illuminated area has a diameter greater than the width of the reflection surface.

20. The position sensing module of claim 15, wherein the carrier is movable relative to the body portion along a moving direction and the reflection surface has a width varied along an axis parallel to the moving direction.

21. The position sensing module of claim 15, further comprising:
a processor, operatively connected to the light sensor, for determining the relative movement amount, in response to the electrical output.

22. An apparatus for use in an imaging system, said apparatus comprising:
means for reflection mounted in the image system, the imaging system comprising a plurality of imaging components, the imaging component comprising an image sensor located in an image plane and a lens element for projecting an image on the image sensor, the lens element defining an optical axis, wherein one of the imaging components is mounted on a carrier for movement in a direction substantially parallel to the optical axis for affecting the projected image on the image sensor, the carrier having a carrier portion adjacent a fixed body portion of the image system, and wherein said means for reflection is provided on one of the carrier portion and the body portion, wherein said means for reflection is located near an edge of a part surface;
means for illumination, disposed on the other of the carrier and body portions spaced from the reflection surface, for producing a light beam to illuminate the reflection surface such that one part of the light beam encounters said means for reflection to form an illuminated area, and another part of the light beam falls off the edge of the part surface, wherein when the carrier is caused to move relative to the body portion, the illuminated area changes; and
means for sensing the light reflected from the illuminated area for providing an electrical output having a relationship to the illuminated area so as to determine the relative movement amount from the electrical output based on the relationship between the electrical output and the illuminated area.
